(19) United States
(12) Patent Application Publication
(10) Pub. No.: US 2005/0056379 A1
(43) Pub. Date: Mar. 17, 2005

(54) Retaining bracket structure for cordless continuous folding blind

(75) Inventor: Ben Hsu, Changhua Hsien (TW)

Correspondence Address: TROXELL LAW OFFICE PLLC, SUITE 1404, 5205 LEESBURG PIKE, FALLS CHURCH, VA, 22041, US

(73) Assignee: Ching Feng Blinds Ind. Co., Ltd.

(21) Appl. No.: 10/660,513

(22) Filed: Sep. 12, 2003

(51) Int. Cl. E06B 3/48

(52) U.S. Cl. 160/84.04

(57) ABSTRACT

A retaining bracket structure for a cordless continuous folding blind includes a continuous folding blind attached to the underside of an upper beam, and a pair of flexible retaining brackets wherein the flexible retaining bracket, of plastic materials, is made up of a pressing plate protruding at the middle section thereof, a pair of C-shaped clamping arms symmetrically extending at both sides of the pressing plate thereof, and a pointed hook bending inwards at each end of the C-shaped clamping arms thereof. In operation, the pressing plate of the flexible retaining bracket is applied from the front to abut against the upper side of the continuous folding blind collected from bottom to top at a desirable position, and the C-shaped clamping arms are bent downwards to extend backwards at the underside thereof till the pointed hooks thereof clamping in reverse at the top of the collected continuous folding blind from the rear thereof. Thus, the collected continuous folding blind is clipped tight at the pressing plate and the C-shaped clamping arms there-between and confined at the C-shaped clamping arms and the pointed hooks therein. Even under the swing of strong wind, the retaining brackets thereof can securely collect and locate the continuous folding blind at a desirable position without easily getting loose or detached there-from in use.

### BACKGROUND OF THE INVENTION

The present invention is related to a retaining bracket structure for a cordless continuous folding blind, including a continuous folding blind attached to the underside of an upper beam, and a pair of flexible retaining brackets wherein the flexible retaining bracket, of plastic materials, is made up of a pressing plate protruding at the middle section thereof, a pair of C-shaped clamping arms symmetrically extending at both sides of the pressing plate thereof, and a pointed hook bending inwards at each end of the C-shaped clamping arms thereof; whereby, the continuous folding blind collected from bottom to top is clipped tight at the pressing plate and the C-shaped clamping arms there-between, and confined at the C-shaped clamping arms and the pointed hooks therein for secure location. Thus, even under the swing of strong wind, the retaining brackets thereof can securely collect and locate the continuous folding blind at a desirable position without easily getting loose or detached there-from in use.

Please refer to FIG. 1. A conventional retaining structure for a continuous folding blind is made up of an upper beam 10, a continuous folding blind 11 attached to the bottom of the upper beam 10 thereof, and a flexible clip 12 having a cavity 121 defined thereon. When the continuous folding blind 11 is collected to the desired position, the flexible clip 12 is applied and pushed from one side of the continuous folding blind 10 to clamp the gathered slats of the folding blind 10 at the cavity 121 therein for location thereof.

There are some drawbacks to such conventional retaining structure of a continuous folding blind. Most of all, the flexible clip 12 is separately applied onto the continuous folding blind 11 from outside. Once under the swing of strong wind, the flexible clip 12 is easily detached from the continuous folding blind 11, disarraying the collected continuous folding blind 11.

### SUMMARY OF THE PRESENT INVENTION

It is, therefore, the primary purpose of the present invention to provide a retaining bracket structure for a cordless continuous folding blind, including a continuous folding blind attached to the underside of an upper beam, and a pair of flexible retaining brackets wherein the flexible retaining bracket, of plastic materials, is made up of a pressing plate, a pair of C-shaped clamping arms symmetrically extending at both sides of the pressing plate thereof, and a pointed hook bending inwards at each end of the C-shaped clamping arms thereof; whereby, the continuous folding blind collected from bottom to top is clipped tight at the pressing plate and the C-shaped clamping arms there-between, and confined at the C-shaped clamping arms and the pointed hooks therein. Thus, even under the swing of strong wind, the retaining brackets thereof can securely collect and locate the continuous folding blind at a desirable position without easily getting loose or detached there-from in use.

### BRIEF DESCRIPTION OF THE DRAWINGS

FIG. 1 is a sectional view of a conventional retaining structure of a cordless continuous folding blind in use.

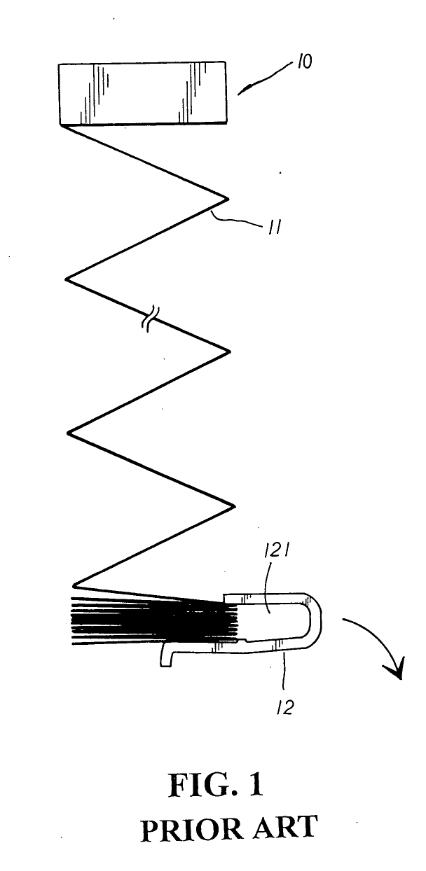

FIG. 2 is a perspective exploded view of the present invention.

FIG. 3 is an enlarged perspective view of the present invention in operation.

FIG. 4 is a sectional view of the present invention in collection.

### DETAILED DESCRIPTION OF THE PREFERRED EMBODIMENTS

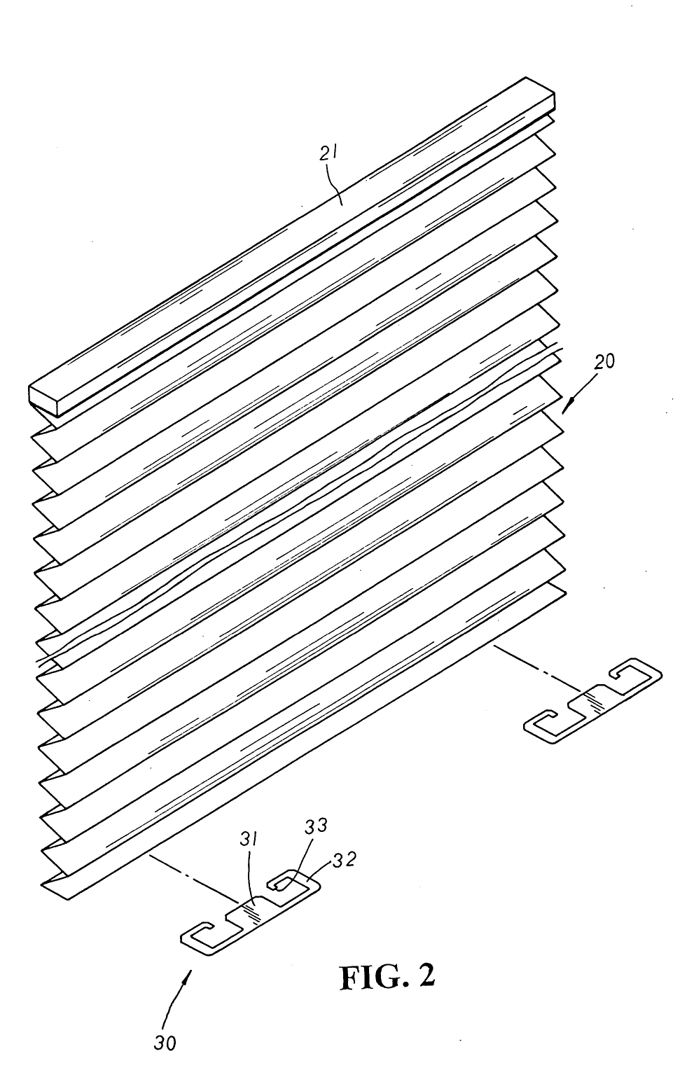

Please refer to FIG. 2. The present invention is related to a retaining bracket structure for a cordless continuous folding blind, including a continuous folding blind 20, and a pair of flexible retaining brackets 30 wherein the continuous folding blind 20 is attached to the underside of an upper beam 21. The flexible retaining bracket 30, of plastic materials, is made up of a pressing plate 31 protruding at the middle section thereof, a pair of C-shaped clamping arms 32 symmetrically extending at both sides of the pressing plate 31 thereof, and a pointed hook 33 bending inwards at each end of the C-shaped clamping arms 32 thereof.

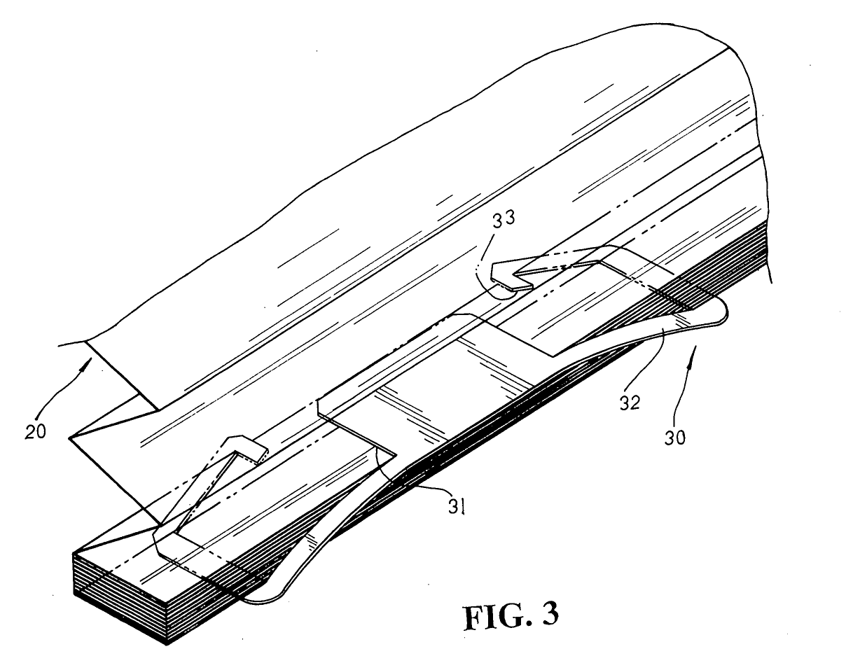

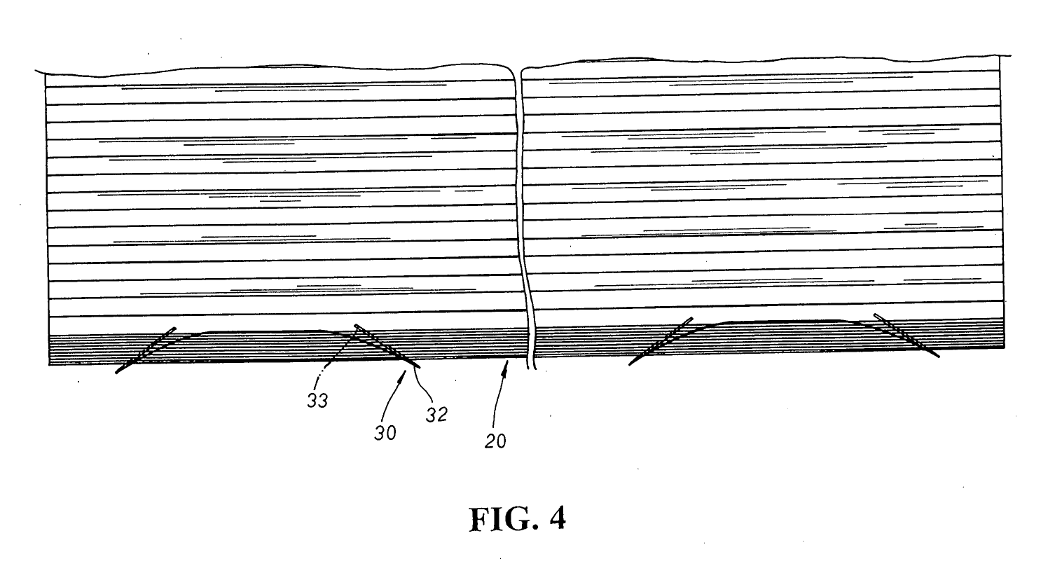

Please refer to FIG. 3. To collect the continuous folding blind 20, the slats of the continuous folding blind 20 thereof are gathered from bottom to top till a desirable position is reached. The pressing plate 31 of the flexible retaining bracket 30 is applied from the front side of the continuous folding blind 20 to abut against the upper side of the collected continuous folding blind 20. The C-shaped clamping arms 32 disposed at both sides thereof are bent downwards respectively to extend backwards at the underside of the collected continuous folding blind 20 thereof with the pointed hooks 33 thereof clamping in reverse at the top of the collected continuous folding blind 20 from the rear side thereof. The collected continuous folding blind 20 is then clipped tight by the pressing plate 31 and the C-shaped clamping arms 32 thereof and confined at the C-shaped clamping arms 32 and the pointed hooks 33 therein for secure location as shown in FIG. 4. Thus, even under the swing of strong wind, the retaining brackets 30 thereof can securely collect and locate the continuous folding blind 20 at a desirable position without easily getting loose or detached there-from in practical use.

1. A retaining bracket structure for a cordless continuous folding blind, including a continuous folding blind, and a pair of flexible retaining brackets wherein the continuous folding blind is attached to the underside of an upper beam; the present invention being characterized by that,
the flexible retaining bracket, of plastic materials, being made up of a pressing plate protruding at the middle section thereof, a pair of C-shaped clamping arms symmetrically extending at both sides of the pressing plate thereof, and a pointed hook bending inwards at each end of the C-shaped clamping arms thereof;
in operation, the pressing plate of the flexible retaining bracket is applied from the front to abut against the upper side of the continuous folding blind collected from bottom to top at a desirable position, and the C-shaped clamping arms are bent downwards to extend backwards at the underside of the collected continuous folding blind thereof till the pointed hooks thereof clamping in reverse at the top of the collected continuous folding blind from the rear thereof; thus, the collected continuous folding blind is clipped tight at the pressing plate and the C-shaped clamping arms there-between and confined at the C-shaped clamping arms and the pointed hooks therein for secure location; even under the swing of strong wind, the retaining brackets thereof can securely collect and locate the continuous folding blind at a desirable position without easily getting loose or detached there-from in use.
